(19) United States
(12) Patent Application Publication
(10) Pub. No.: US 2025/0068673 A1
(43) Pub. Date: Feb. 27, 2025

(54) AUDIO ANALYSIS SYSTEM WITH QUERY PROCESSING

(71) Applicant: SRI International, Menlo Park, CA (US)

(72) Inventors: Mitchell Leigh McLaren, Everton Park (AU); Aaron Dennis Lawson, Sutter Creek, CA (US)

(21) Appl. No.: 18/813,647

(22) Filed: Aug. 23, 2024

Related U.S. Application Data
(60) Provisional application No. 63/534,744, filed on Aug. 25, 2023.

(51) Int. Cl. G06F 16/683; G06F 16/61; G10L 15/00

(52) U.S. Cl. CPC G06F 16/685; G06F 16/61; G10L 15/005

(57) ABSTRACT

A computing system is configured to obtain a plurality of media files that each includes speech of one or more speakers. The computing system is further configured to process the plurality of media files to generate indexed data, wherein the indexed data includes a corresponding embedding for each speaker of the one or more speakers identified in the media file and a corresponding one or more keywords identified in the speech in the media file. The computing system is further configured to receive an indication at least one of a selection of a particular speaker from the one or more speakers or a selection of a particular keyword from a plurality of keywords. The computing system is further configured to generate one or more correlations based on the indexed data. The computing system is further configured to output an alert regarding the one or more correlations.

### RELATED APPLICATIONS

This application claims the benefit of U.S. Patent Application No. 63/534,744, filed 25 Aug. 2023, the entire contents of which is incorporated herein by reference.

### GOVERNMENT RIGHTS

This invention was made with U.S. Government support under Contract Number N4175622C4352 awarded by the Navy Engineering Logistics Office. The Government has certain rights in this invention.

### TECHNICAL FIELD

This disclosure relates to audio analysis.

### BACKGROUND

A wide of variety of sites on both the Clearnet of the Internet (e.g., social media sites) as well as the dark web (e.g., darknets, sites on the deep web, etc.) host media files of language spoken by a variety of speakers. Organizations such as law enforcement agencies may use these audio files to identify relationships between individuals, codewords used by the individuals, and other information.

### SUMMARY

In general, the disclosure describes an analysis system having a novel architecture for obtaining, analyzing, and indexing audio data to enable efficient querying by a user. “Audio data,” as used herein, can include any collection of data that includes human speech. Audio data is present in a media file, which may be an audio file or a multimedia file, such as video for instance.

Media files can be obtained from one or more sources that provide media files over a network. To obtain the media files, the analysis system may crawl a variety of sites, such as social media sites and dark web sites for media files that include audio data including speech, the speech including words spoken in one or more languages. The analysis system may process the audio data to identify speakers and keywords. The analysis system may index the audio data in a form that provides users with an efficient querying capability to link speakers, based on their voices, across social network platforms, assist in finding links to unknown speakers in the same audio file, or connect speakers through common language use, such as the use of similar keywords. The indexed audio data may then be efficiently queried by a user of the analysis system.

The techniques may provide one or more technical advantages that realize at least one practical application. For instance, the analysis server may use clustering of speaker embeddings to enable rapid identification of media files that include language spoken by a speaker of interest. In addition, the analysis system may use the clusters of speakers to identify other speakers associated with the speaker of interest (e.g., speakers who talk in the same media file). In another example, the analysis system may enable efficient querying of the media files by a user to identify media files that include speakers speaking a specified keyword provided in a user query.

In an example, a method includes obtaining, by a computing system and from one or more sources that provide media files over one or more networks, a plurality of media files that each includes speech of one or more speakers; processing, by the computing system, the plurality of media files to generate indexed data, wherein the indexed data includes, for each media file of the plurality of media files, a corresponding embedding for each speaker of the one or more speakers identified in the media file and a corresponding transcript of speech for each language identified in the speech in the media file; receiving, by the computing system, an indication of at least one of a selection of a particular speaker from the one or more speakers or a selection of a particular keyword from a plurality of keywords; generating, by the computing system, one or more correlations based on the indexed data, wherein the one or more correlations include at least one of an association among the one or more speakers or an association among keywords detected in the transcripts as spoken by the one or more speakers; and outputting, by the computing system, based on the one or more correlations, an indication regarding the one or more correlations.

In another example, a computing system includes memory and one or more programmable processors in communication with the memory and configured to obtain, from one or more sources that provide media files over one or more networks, a plurality of media files that each includes speech of one or more speakers; process the plurality of media files to generate indexed data, wherein the indexed data includes, for each media file of the plurality of media files, a corresponding embedding for each speaker of the one or more speakers identified in the media file and a corresponding transcript of speech for each language identified in the speech in the media file; receive an indication of at least one of a selection of a particular speaker from the one or more speakers or a selection of a particular keyword from a plurality of keywords; generate one or more correlations based on the indexed data, wherein the one or more correlations include at least one of an association among the one or more speakers or an association among keywords detected in the transcripts as spoken by the one or more speakers; and output, based on the one or more correlations, an indication regarding the one or more correlations.

In yet another example, non-transitory computer-readable media comprises instructions that, when executed by one or more processors, causes the one or more processors to obtain, from one or more sources that provide media files over one or more networks, a plurality of media files that each includes speech of one or more speakers; process the plurality of media files to generate indexed data, wherein the indexed data includes, for each media file of the plurality of media files, a corresponding embedding for each speaker of the one or more speakers identified in the media file and a corresponding transcript of speech for each language identified in the speech in the media file; receive an indication of at least one of a selection of a particular speaker from the one or more speakers or a selection of a particular keyword from a plurality of keywords; generate one or more correlations based on the indexed data, wherein the one or more correlations include at least one of an association among the one or more speakers or an association among keywords detected in the transcripts as spoken by the one or more speakers; and output, based on the one or more correlations, an indication regarding the one or more correlations.

The details of one or more examples of the techniques of this disclosure are set forth in the accompanying drawings and the description below. Other features, objects, and advantages of the techniques will be apparent from the description and drawings, and from the claims.

### BRIEF DESCRIPTION OF DRAWINGS

FIG. 1 is a block diagram illustrating an example computing environment that includes an analysis system for media consolidation and analysis, and a user system, in accordance with techniques of the disclosure.

FIG. 2 is a block diagram illustrating an example analysis system for media consolidation and analysis, in accordance with techniques of the disclosure.

FIGS. 3A-3C depict database entries, in accordance with techniques of the disclosure.

FIG. 4 is an example user interface of an analysis system, in accordance with techniques of the disclosure.

FIG. 5 is an example user interface of an analysis system, in accordance with techniques of the disclosure.

FIG. 6 is a flowchart illustrating an example mode of operation of an analysis system, according to techniques described in this disclosure.

Like reference characters refer to like elements throughout the figures and description.

### DETAILED DESCRIPTION

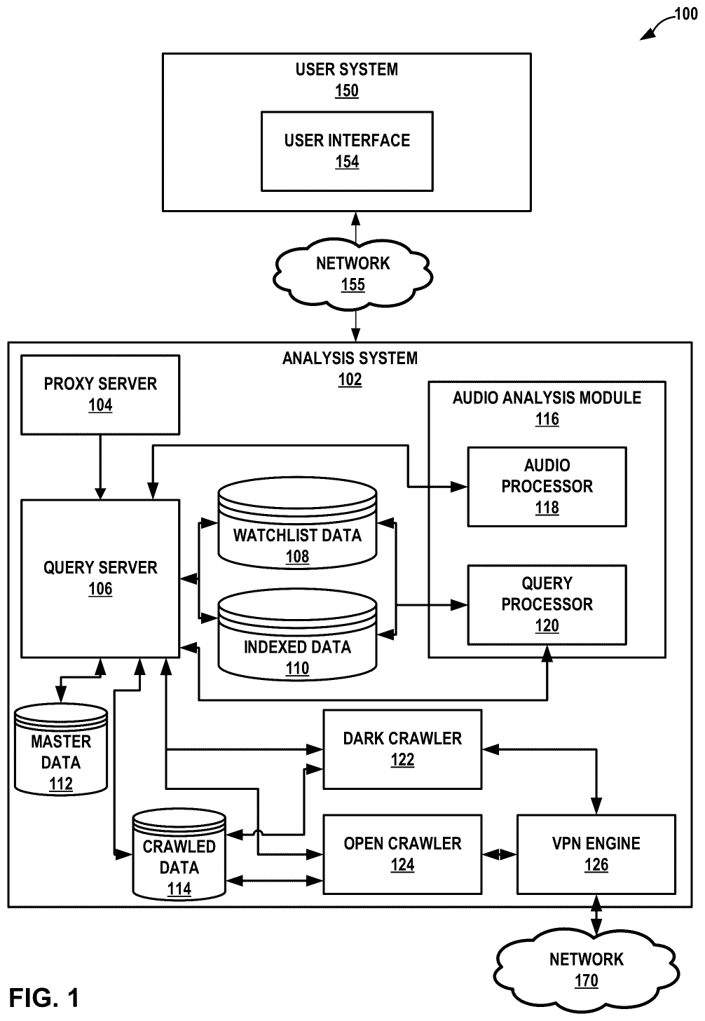

FIG. 1 is a block diagram illustrating an example computing environment 100 that includes an analysis system 102 and a user system 150, in accordance with techniques of the disclosure. Analysis system 102 may be one or more types of computing systems and/or device, such as a server, mainframe, supercomputer, cloud computing environment, distributed computing environment, virtualized computing environment, desktop computer, laptop computer, tablet computer, smartphone, or other type of computing device. Analysis system 102 may include one or more software components that are executed by one or more processors of analysis system 102, where the one or more processors may include one or more of Field-Programmable Gate Arrays (FPGAs), Application-Specific Integrated Circuits (ASICs), processors with one or more cores, and/or compute nodes among other types of processors. In some examples, user system 150 may execute one or more processes of analysis system 102.

Computing environment 100 includes user system 150. User system 150 may be one or more types of computing device such as a desktop computer, laptop computer, tablet computer, smartphone, wearable computing device (e.g., AR/VR goggles and/or glasses) and other types of computing device.

User system 150 includes user interface (UI) 154. User interface 154 may include graphical user interface (GUI), command-line interface, browser, voice interface, conversational assistant, and/or other type of user interface. One or more components of user system 150 may generate UI 154. For example, analysis system 102 and/or one or more other components of user system 150 may generate user interface 154. User interface 154 may use one or more components such as a display component, speaker component, microphone, or other input/output or communication devices of user system 150. In some examples, user interface 154 may be a GUI displayed within a browser (e.g., user interface 154 may be generated as a web page by analysis system 102 and displayed by a browser executed by user system 150).

User system 150 interacts with analysis system 102 that analyzes media files to identify speakers and keywords. (As used herein, a “keyword” can refer to a single word or to a phrase of multiple words, i.e., a key phrase.) A user of user system 150 may seek to quickly identify media files that include a particular speaker and identify other speakers who speak in the same media files as the particular speaker. Additionally, the user of user system 150 may seek to quickly identify media files in which particular keywords are spoken. Further, the user of user system 150 may seek to identify speakers and/or keywords in media obtained from a variety of sources such as social media sites and sites on the dark web. Conventional media analysis systems may struggle to quickly identify relationships and correlations among speakers and keywords. For example, such systems may take several minutes per speaker to identify correlations. In addition, the systems may be unable to crawl sites for media files.

In addition, social media platforms are constantly having media uploaded. Some users may exploit the platform for malicious or nefarious purposes. These users often hold multiple accounts across platforms on both open and dark web services. Law enforcement agencies may benefit from connecting the same accounts, as well as understanding the content of media posted by such users, including associates such users communicate with in the same media. Determining these account connections and associates (or networks) may be a difficult, slow, and labor intensive task. In addition, current techniques and system may require the reporting of accounts to enforcement agencies followed by manual seeking of media and information related to the task at hand. Also, social media companies may find it challenging to identify accounts for removal or other purposes from their platforms. Further, enterprise companies may find it difficult to determine what employees are doing across multiple social media channels that may impact the enterprise companies.

In accordance with techniques of this disclosure, analysis system 102 may crawl sources for media files and process the media files to identify correlations among speakers and keywords. Analysis system 102 may crawl a plurality of sources, such as social media sites and sites on the dark web, for media files. Analysis system 102 may process the media files to extract speakers and transcripts of speech included therein. In addition, analysis system 102 may maintain a watchlist of speakers and keywords and determine when speakers and/or keywords are detected in newly added files. Analysis system 102 may generate indications for user system 150 that indicate when analysis system 102 determines that a speaker and/or keyword/phrase included in the watchlist is identified in a media file. An indication may be audible or output via a display, for example.

That is, analysis system 102 may automatically crawl data on multiple platforms based on keywords entered by the user. There can be multiple keywords across multiple languages. The media that is located is downloaded and processed with speech processing tools to perform (1) speech activity detection, (2) gender ID, (3) language ID, (4) speech transcription in the language detected, (5) speaker diarization and detection based on registered speaker voices from the user, and (6) keyword detection based on registered key words registered by the user. When detections are made (i.e., a speaker of interest located in a file), all of this information is presented in a user interface as an ‘indication’ for the user to investigate.

In this way, analysis system 102 may enable automatically (1) locating media of potential interest, (2) processing the information to be concise for rapid retrieval at a later date, (3) providing transcripts with highlighted keywords of interest, and (4) producing a speaker network graph when two speakers of interest that have been registered are found speaking in the same media file. The system maintains a large and efficient database of collected media over time such that new speakers or keywords registered are quickly compared against the database for hits. In addition, analysis system 102 may facilitate rapid information retrieval for enforcement and homeland security agencies across media of multiple languages and provide actionable information in a fraction of time compared to traditional system. Analysis system 102 may facilitate regular and automatic seeking of relevant information from the registered keywords/speakers from the users of the system. Further, analysis system 102 list which platforms a speaker has been found and enable the submission of a database for processing rather than require the use of an online system.

User system 150 may communicate with analysis system 102. User system 150 may communicate with analysis system 102 via one or more communication components, such as radios, modems, physical network interfaces, and other types of communication components. For example, user system 150 may communicate with analysis system 102 via a network, such as network 155 and/or a private network, using one or more network components. Network 155 and network 170 may be the same network in some cases. In some examples, analysis system 102 executes user interface 154 by which a user may interface with the system and provides the user interaction capabilities otherwise attributed herein to user system 150.

Computing environment 100 may include one or more networks such as network 170. Network 170 may be a wide area network (WAN), such as the Internet. Analysis system 102 and/or user system 150 may be connected to network 170. As noted above, analysis system 102 and user system 150 may communicate with each other via network 155, which although illustrated as separate from network 170, may include or be combined with network 170. For example, analysis system 102 and user system 150 may communicate with each other via a virtual private network (VPN) that is routed via network 170.

User system 150 may provide queries (alternatively referred to as “requests” throughout) to analysis system 102. User system 150 may generate queries in response to user input via user interface 154 and provide the queries to analysis system 102. The user input may be in the form of text or spoken input, for instance, received at user system 150 via an input/output or communication device. In an example, a user of user system 150 provides user input to user system 150 to request that analysis system 102 identify speakers that speak in the same one or more media files as a particular speaker. User system 150 generates an indication of the user's request (i.e., a query) and sends the indication of the request to analysis system 102.

User system 150 and analysis system 102 may communicate via one or more encrypted connections such as a VPN tunnel provided by proxy server 104. Analysis system 102 may include proxy server 104. Proxy server 104 may be a proxy server and/or service such as a Hypertext Transfer Protocol Secure (HTTPS) reverse proxy. Proxy server 104 may manage connections with other computing systems and devices, such as user system 150. Proxy server 104 may determine whether a system or device attempting to connect to analysis system 102 has the correct credentials using, e.g., certificate authentication. For example, proxy server 104 may receive a request from user system 150. Proxy server 104 may determine whether user system 150 has the one or more certificates that are required for proxy server 104 to allow user system 150 to access functionality of analysis system 102. Proxy server 104 may deny access to one or more functions of analysis system 102 by user system 150 if user system 150 does not have the correct certificates.

Proxy server 104 may establish secure communications between user system 150 and analysis system 102. Proxy server 104 may establish a connection between user system 150 and analysis system 102 that is end-to-end encrypted to preserve the security and confidentiality of information communicated between user system 150 and analysis system 102. In an example, proxy server 104 determines that user system 150 has the correct certificate to access analysis system 102. Proxy server 104 establishes an encrypted connection between user system 150 and analysis system 102. Proxy server 104 may establish a connection between user system 150 and analysis system 102 that enables user system 150 to request analysis system 102 to perform one or more actions. For example, proxy server 104 may enable user system 150 to provide a request to query server 106 of analysis system 102.

One or more components of analysis system 102 may encrypt traffic between analysis system 102 and user system 150 as well as data of analysis system 102. Proxy server 104 may encrypt traffic between analysis system 102 and user system 150. In addition, analysis system 102 may encrypt data of one or more components of analysis system 102, such as watchlist data 108 and indexed data 110. For example, analysis system 102 may encrypt data of the one or more components of analysis system 102 when analysis system 102 is executed by a cloud computing system to ensure the security and confidentiality of analysis system 102.

Analysis system 102 includes query server 106. Query server 106 may be a software and/or hardware component or subsystem of analysis system 102. Query server 106 may orchestrate and manage one or more processes of analysis system 102 and/or manage the storing and organizing of data maintained by analysis system 102. Additionally, query server 106 may facilitate speaker and/or text comparisons when new data is obtained or provided to analysis system 102.

Query server 106 may facilitate an initial enrollment process that includes an initial crawl for media files and processing the media files. Query server 106 may facilitate an initial process to obtain media files for analysis. For example, query server 106 may cause one or more components of analysis server 102 to crawl network(s) to identify and obtain media files and to process the media files. Query server 106 may facilitate the initial enrollment process in response to an indication and/or request from user system 150. For example, query server 106 may cause dark crawler 122 and open crawler 124 to begin obtaining a plurality of sites for a plurality of media files as part of an initial enrollment process in response to an indication from user system 150.

Analysis system 102 includes dark crawler 122. Dark crawler 122 may be a hardware and/or software component of analysis system 102. Dark crawler 122 may crawl addresses consistent with one or more darknets (e.g., sites within the dark web, sites not indexed by a search engine, sites not accessible using a traditional web browser, etc.). Dark crawler 122 may use one or more browsers or other tools to access data on darknets. For example, dark crawler 122 may use The Onion Router (Tor) to access one or more sites and/or sources that are not publicly visible. Dark crawler 122 may include specialized functionality necessary to crawl websites consistent with one or more darknets. For example, dark crawler 122 may include specialized functionality that enables crawling of sites that are only accessible via onion routing (e.g., web address ending with “.onion”).

Analysis system 102 includes open crawler 124. Open crawler 124 may be a hardware and/or software component of analysis system 102. Open crawler 124 may crawl sites on the open web (e.g., the Clearnet, sites accessible to the general public with a web browser, etc.). For example, open crawler 124 may crawl social media sites for media files.

Dark crawler 122 and open crawler 124 may obtain metadata in addition to media files from sources. Dark crawler 122 and open crawler 124 may obtain metadata that includes public links, timestamps (e.g., timestamps of the media files, timestamps of when media files were uploaded/last updated, username that posted the media files, etc.). For example, dark crawler 122 and open crawler 124 may obtain the username of the poster of a file and associate the username with the file.

Analysis system 102 include VPN engine 126. VPN engine 126 may be a hardware and/or software component of analysis system 102. VPN engine 126 may connect dark crawler 122 and/or open crawler 124 to network 170 170 via one or more VPNs. VPN engine 126 may initialize and maintain VPNs to one or more sources on WAN 120 (e.g., social media sites, dark web sites, etc.). VPN engine 126 may initialize VPNs to the one or more sources to enable encryption of traffic to analysis system 102 and to maintain the confidentiality of analysis system 102. VPN engine 126 may establish a private and anonymous TCP connection to a remote Internet service and instantiate an Internet service. VPN service 126 may instantiate the Internet service to maintain flow-level origin anonymity, congestion control, comms integrity, secrecy, and user configurability, as well as make the origin of Internet service (e.g., analysis server 102) difficult to trace by third parties. VPN engine 126 may periodically or aperiodically rotate VPNs used by dark crawler 122 and/or open crawler 124. For example, VPN engine 126 may rotate a VPN used by dark crawler 122 every 15 minutes.

Analysis system 102 includes crawled data 114. Crawled data 114 may be a database or other type of data storage that stores media files obtained by dark crawler 122 and/or open crawler 124. In some examples, crawled data 114 may provide a data buffer for incoming media files from dark crawler 122 and open crawler 124. Crawled data 114 may be a database with one or more types of data structure that stores data crawled and obtained by dark crawler 122 and open crawler 124. Dark crawler 122 and open crawler 124 may store media files that each include speech of one or more speakers in crawled data. Crawled data 114 may store audio data that has been stripped from media files by dark crawler 122 and/or open crawler 124. For example, dark crawler 122 and open crawler 124 may strip audio data from media files and store the audio data in crawled data 114.

Analysis system 102 include audio analysis module 116. Audio analysis module 116 may be a hardware and/or software component of analysis system 102 that processes media files, such as the data in crawled data 114. Audio analysis module 116 may implement audio analysis software such as OLIVE audio analysis software, available from SRI International of Menlo Park, California. Audio analysis module 116 may analyze media files and audio data, such as media files that include audio data stored in crawled data 114. In some examples, audio analysis module 116 may process two or more files in parallel. Audio analysis module 116 may process audio data that includes language spoken in one or more languages such as English, French, Spanish, Mandarin, Russian, Korean, Farsi, Pashto, and Arabic dialects, among other languages. Although shown as part of analysis system 102, in some examples, audio analysis module 116 is a service provided by a remote computing system, such as a public or private cloud.

Audio analysis module 116 includes audio processor 118. Audio processor 118 may be a hardware and/or software component of analysis system 102. Audio analysis module 116 may analyze media files to detect speakers and keywords. Audio processor 118 may execute an audio processing workflow that includes generating an analysis of audio that includes one or more outputs, such as a transcript of language spoken in the media files that includes one or more keywords identified in speech of media file, speaker gender identifiers, vectorized representations of speakers in the media files (e.g., vectors, embeddings, etc.), time stamps (e.g., time stamps of when a particular speaker is speaking within a media file, time stamps of particular events within a media file, time stamps of when keywords are spoken in a media file, etc.), and/or language identifiers (e.g., identifiers of language(s) spoken in a media file).

Audio processor 118 may process speech activity in media files as part of the audio processing workflow. Audio processor 118 may analyze a media file to detect speech within the media file and generate one or more time stamps of the speech within the media file. Audio processor 118 may determine whether speech is present in the audio file or whether the media file contains audio that is not speech. In an example, audio processor 118 determines that a given media file only contains ambient noise and does not contain any recognizable speech. Audio processor 118 causes one or more components of analysis system 102, such as crawled data 114, to discard the audio file that does not contain any recognizable speech.

In some examples, audio processor 118 may identify audio events within media files other than speech. Audio processor may identify audio events that include doors slamming, car horns, background audio, music, and other types of audio events. In addition, audio process 118 may generate correlations that include associations among audio events in different media files. For example, audio processor 118 may correlate the sound of car horns and traffic in one media file with the sound of car horns and traffic in another media file.

Audio processor 118 may apply diarization to the media files as part of the audio processing workflow. Audio processor 118 may apply diarization to segment and cluster the one or more speakers who speak language in the media files. Audio processor 118 may segment sections of speech within a media file into speaker turns. For example, audio processor 118 may determine when a given speaker within a media file begins and ceases speaking and when the next speaker begins and ceases speaking. Audio processor 118 may cluster the segments with clusters of speakers, e.g., clusters based on speaker embeddings. Audio processor 118 may cluster one or more speakers identified within an audio file with other speakers identified from other files. For example, audio processor 118 may cluster speech from the audio into single-language excerpts, as well as single-speaker clusters.

Audio processor 118 may determine whether a speaker identified in a media file is a speaker on a watchlist (e.g., in watchlist data 108). During the application of diarization to media files, audio processor 118 may generate an embedding for each speaker identified in a media file. Audio processor 118 may use one or more machine learning models, such as a time-delay deep neural network (TDNN), to generate the speaker embeddings. For example, audio processor 118 may generate an embedding that is a representation of 512 floating point numbers of a cluster of speakers. Audio processor 118 may store the speaker embeddings in a database, such as watchlist data 108. For example, audio processor 118 may store the speaker embeddings in watchlist data 108 to enable queries to be made based on watchlist data 108.

Audio processor 118 may identify the gender of each speaker cluster. Audio processor 118 may use a gender recognition module to generate a gender label of the speaker represented by the speaker cluster. For example, audio processor 118 may process a speaker cluster through a gender recognition plugin to generate a gender label of the speaker cluster. Audio processor 118 may associate the gender label with the speaker cluster and store the gender label in a database such as watchlist data 108 and/or indexed data 110.

Audio processor 118 may identify one or more languages spoken in each media file. Audio processor 118 may apply a language recognition system to identify the language spoken in a media file. Audio processor 118 may apply a language recognition system that is hardened to handle noisy conditions and open-source data. For example, audio processor 118 may determine that a given speaker within a media file with substantial background noise is speaking Korean. Audio processor 118 may support the addition of plugins that provide one or more functions. For example, audio processor 118 may support the addition of plugins that provide audio event detection, audio enhancement such as music suppression, and other functions.

Audio processor 118 may generate text of spoken language in the media files. Audio processor 118 may generate the text based on detecting a language in the media files for which automatic speech recognition (ASR) and/or speech-to-text transcription is available. For example, audio processor 118 may generate a transcript of a spoken language for a media file in response to determining that the media file includes spoken language in a language for which ASR is available. Audio processor 118 may generate transcripts in one or more languages, such as English, French, Spanish, Mandarin, Russian, Korean, Farsi, Pashto, Iraqi Arabic, and Levantine Arabic among other languages. Audio processor 118 may enable further additions to the languages that audio processor 118 processes. For example, audio processor 118 may enable a user or administrator to add languages to the languages that audio processor 118 processes. Audio processor 118 may generate transcripts that are time-aligned (e.g., aligned with the spoken language in the time domain).

Audio processor 118 may generate transcripts that are searchable. Audio processor 118 may generate searchable transcripts to enable another analysis system and/or a system such as user system 150 to search the transcripts for keywords. In an example, audio processor 118 generates a plurality of searchable transcripts. Audio processor 118 enables user system 150 to search for media files that include a particular phrase using the searchable transcripts through adding the particular phrase to a watchlist stored in watchlist data 108. Analysis system 102 searches for media files through searching the searchable transcripts for the particular phrase. Audio processor 118 may store the searchable transcripts in watchlist data 108.

Analysis system 102 includes watchlist data 108. Watchlist data 108 may include one or more databases, data structures, containerized storage, and/or other types of storage. Analysis system 102 may store information regarding a watchlist in watchlist data 108. Analysis system 102 may information regarding the watchlist that includes text-based keywords and/or phrases. For example, analysis system 102 may store information regarding keywords of interest to user system 150 in watchlist data 108.

Analysis system 102 may store data regarding speakers, such as enrolled speakers or speakers identified in media files. Analysis system 102 may store information regarding speakers (e.g., identifiers of the speakers enrolled in analysis system 102) and other speakers as speaker vectors or models in watchlist data 108. Analysis system 102 may store speaker vectors that are vectorized representations of the speakers and one or more characteristics of the speakers. For example, analysis system 102 may store speaker embeddings that are 512 element vectors in watchlist data 108. Analysis system 102 may store speaker embeddings in response to an enrollment of a speaker by query server 106. Additionally, analysis system 102 may store embeddings of speakers that are identified from media files (e.g., media files in crawled data 114).

Analysis system 102 includes indexed data 110. Indexed data 110 may include one or more databases, data structures, containerized storage, and/or other type of data storage. Analysis system 102 may store information regarding media files in indexed data 110. Analysis system 102 may store information such as metadata of media files, transcripts of the media files, and vectors associated with the media files in indexed data 110. Analysis system 102 may manage information stored in indexed data 110 based on one or more factors. For example, analysis system 102 may manage the storage of media files based on the length of speech within the media files and the number of speaker clusters detected. Analysis system 102 may update the indexed data 110 in response to the enrollment of a new speaker. In addition, analysis system 102 may process media files to generate indexed data 110. For example, analysis system 102 may cluster excerpts from media files to process the media files into indexed data 110

In some examples, query server 106 may enroll (“register”) new speakers. Query server 106 may facilitate the enrollment in response to an addition of a new audio file to indexed data 110. In an example, a user via user system 150 provides a voice sample for a speaker to analysis system 102. Audio analysis module 116 generates a speaker embedding for the voice sample and

In another example, query server 106 determines that a new media file has been added to indexed data 110. Query server 106 causes audio analysis module 116 to process the new media file. Audio analysis module 116 processes the new media file and generates two speaker embeddings representing the two speakers identified in the new media file. Query server 106 compares the two speaker embeddings to watchlist data 108 and determines that one of the speakers is already present in watchlist data 108 and associates the new media file with that speaker. Query server 106 determines that the other speaker is not present in watchlist data 108 and creates a new entry for that other speaker in watchlist data 108. Query server 106 may provide an indication to user system 150 if query server 106 determines that there is a match between a speaker in a new media file and a speaker in watchlist data 108.

Query server 106 may facilitate the enrollment of a new speaker based on a request from user system 150. Query server 106 may receive requests from user system 150 to enroll a particular speaker. For example, query server 106 may receive a request to enroll a particular speaker selected from a media file by user system 150. Query server 106 may cause audio analysis module 116 to process the selection of the particular speaker to determine information regarding the particular speaker (e.g., other speakers that speak in the same media files as the particular speaker, generate an embedding of the particular speaker, a gender identifier of the particular speaker, etc.). Audio analysis module 116 may use one or more components, such as query processor 120, to determine the information regarding the speaker and provide the results to user system 150. Analysis system 102 may provide the information to user system 150 for display in user interface 154.

Analysis system 102 includes query processor 120. Query processor 120 may be a hardware and/or software component of analysis system 102. In some examples, query processor 120 may execute in a virtualized container or other virtual compute instance. Query processor 120 may process queries for speakers, keywords, and other information. For example, query processor 120 may process a query to identify media files in which a particular speaker speaks. Query processor 120 may use one or more techniques for comparing speaker vectors and data in indexed data 110. For example, query processor 120 may use Dynamic Condition-Aware Probabilistic Linear Discriminant Analysis (DCA-PLDA) to compare speaker vectors and indexed audio. Query processor 120 may use one or more types of analysis as a scoring backend to dynamically adapt to conditions of speaker to speaker comparison (e.g., comparing newly added audio of a speaker to the speaker vectors in watchlist data 108).

Query processor 120 may process text comparisons. Query processor 120 may process text comparisons in response to query server 106 receiving a request from user system 150 to query particular keywords. In an example, query server 106 adds a new keyword to watchlist data 108. Audio analysis module 116 causes query processor 120 to compare the new keyword to data in indexed data 110. Query processor 120 may use one or more techniques to process text comparisons. For example, query processor 120 may use a large-vocabulary speech recognition system to generate one-based transcriptions that are scanned to locate keywords. In addition, query processor 120 may use stemming to locate keywords based on their root rather than singular/plural and other basis. In some examples, query processor 120 may process text-based searches during audio processing of media files.

Analysis system 102 includes master data 112. Master data 112 may be a database with one or more data structures and/or other type of data storage. Analysis system 102 may store information regarding correlations between watchlist data 108 and indexed data 110. Analysis system 102 may generate master data 112 by matching keywords and/or speakers included in watchlist data 108. Analysis system 102 may generate master data by determining the ID of a language spoken (e.g., “English”) and then matching keywords in that language. For example, analysis system 102 may store information regarding a correlation identified between a newly crawled/added media file and a speaker from watchlist data 108 in master data 112. Analysis system 102 may generate the correlation from different media files sourced by different sources that provide media files over a network. Analysis system 102 may generate correlations based on indexed data 110, where the correlations include at least one of an association among one or more speaker or an association among keywords spoken by the one or more speakers. For example, analysis system 102 may generate master data 112 by matching keywords in watchlist data 108 to transcripts of media files in indexed data 110.

Analysis system 102 may output an indication based information in master data 112. Analysis system 102 may generate and output an indication in response to a new entry added to master data 112 and/or based on a correlation. Analysis system 102 may output an indication regarding a correlation or a new entry to one or more recipients. In an example, audio analysis module 116 determines that there is a correlation between a speaker in a newly added media and a speaker in watchlist data 108. Audio analysis module 116 updates master data 112 based on the determination of the correlation. Analysis system 102 outputs an indication based on the updated information in master data 112 that includes information from master data 112. Analysis system 102 then provides the indication to user system 150.

The techniques of this disclosure may provide one or more advantages. The use of watchlist data 108 and indexed data 110 may enable analysis system 102 to quickly identify media files in which a particular speaker is present. For example, analysis system 102 may correlate speakers in media files to speaker identifiers stored in watchlist data 102 and provide an indication to user system 150. In addition, analysis system 102 may extract speaker embeddings from a plurality of media files and store the embeddings in indexed data 110 to enable analysis system 102 to effectively and rapidly identify speakers having speech in media files. Further, the techniques of this disclosure may enable organizations, such as law enforcement and social media companies, to identify accounts, patterns across accounts, and/or other relevant activity. In addition, the techniques of this disclosure may enable enterprise companies to determine activity by their employees across multiple social media platforms that may impact the enterprise company.

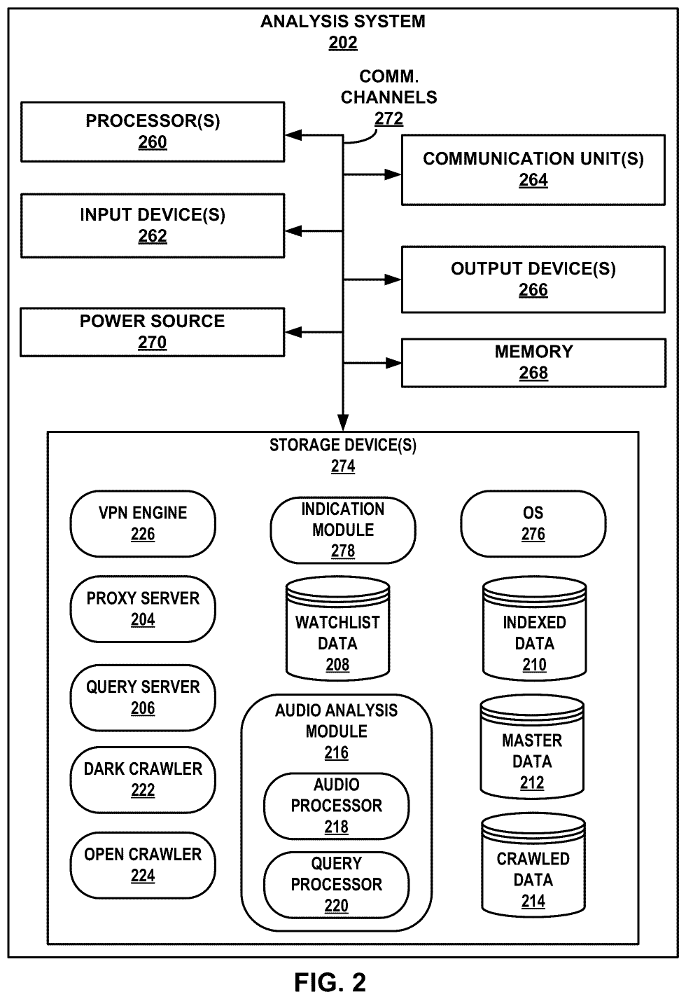

FIG. 2 is a block diagram illustrating an example analysis system 202, in accordance with techniques of the disclosure. Analysis system 202 is an example instance of analysis system 102 of FIG. 1.

Analysis system 202 includes one or more of processors 260. Processors 260 may include one or more types of processors. For example, processors 260 may include one or more of FPGAs, ASICs, graphics processing units (GPUs), central processing units (CPUs), reduced instruction set (RISC) processors, and/or other types of processors or processing circuitry. Processors 260 may execute the instructions of one or more programs and/or processes of analysis system 202. For example, processors 260 may execute instructions of a process stored in memory 268.

Analysis system 202 includes memory 268. Memory 268 may include one or more types of volatile data storage such as random access memories (RAM), dynamic random access memories (DRAM), static random access memories (SRAM), and other forms of volatile memories known in the art. Memory 268 may additionally or alternatively include one or more types of non-volatile data storage. Memory 268 may store data, such as instructions for one or more processes of analysis system 202. For example, memory 268 may store instructions of an operating system for execution by processors 260. Memory 268 may store data provided by one or more components of analysis system 202. For example, memory 258 may store information provided by communication units 264.

Analysis system 202 includes one or more of communication units 264. Communication units 264 may include one or more types of communication units/components such radios, modems, transceivers, ports, and/or other types of communication components. Communication units 264 may communicate using one or more communication protocols such as WIFI, BLUETOOTH, cellular communication protocols, satellite communication protocols, Asynchronous Transfer mode (ATM), ETHERNET, TCP/IP, optical network protocols such as Synchronous Optical Networking (SONET) and Synchronous Digital Hierarchy (SDH), and other types of communication protocols. Communication units 264 may enable analysis system 202 to communicate with one or more computing systems and devices. For example, communication units may enable analysis system 202 to communicate with a user system such as user system 150 as illustrated in FIG. 1.

Analysis system 202 includes one or more of input devices 262. Input devices 262 may include one or more devices and/or components capable of receiving input such as touchscreens, microphones, keyboards, mice, and other types of input devices. Input devices 262 may enable a user of analysis system 202 to provide input to analysis system 202. For example, input devices 262 may enable a user of analysis system 202 to type input via a keyboard.

Analysis system 202 includes one or more of output devices 266. Output devices 266 may include one or more devices and/or components capable of generating output such as displays, speakers, haptic engines, light indicators, and other types of output devices. Output devices 266 may enable analysis system 202 to provide output to a user of analysis system 202. For example, analysis system 202 may provide output of results of a search for a particular speaker via a display of output devices 266.

Analysis system 202 includes power source 270. Power source 270 may include one or more sources of power for analysis system 202 such as solar power, battery backup, generator backup, and power from an electrical grid. For example, analysis system 202 may be powered by power source 270 that includes a connection to an electrical grid and a generator backup.

Analysis system 202 includes one or more of communication channels 272 (illustrated as “COMM. CHANNELS 272” in FIG. 2). Communication channels 272 may include one or more communication channels that interconnect one or more components of analysis system 202. Communication channels 272 may include one or more types of communication channels such as hardware interconnects and/or software interconnects, networks, busses, or other types of channels. For example, communication channels 272 may include a hardware interconnect between memory 268 and storage devices 274.

Analysis system 202 includes one or more of storage devices 274. Storage devices 274 may include one or more devices and/or components capable of storing data. Storage devices 274 may include one or more types of non-volatile storage devices such as magnetic hard drives, magnetic tape drives, solid state drives, NVM Express (NVMe) drives, optical media, and other types of non-volatile storage. In some examples, storage devices 274 may include one or more types of volatile storage devices. Storage devices 274 may include one or more databases which may be integrated within the one or more storage components of storage devices 274 and/or external to and communicatively coupled with analysis system 202 (e.g., such that analysis system 202 may read and write to the databases). Storage devices 274 may include data encrypted with one or more types of encryption. For example, storage devices 274 may be encrypted with types of encryption such as Rivest-Shamir-Adleman (RSA) cryptosystem, Advanced Encryption Standard (AES) encryption, post-quantum encryption (PQC), and other types of encryption.

Storage devices 274 may store information of one or more software components of analysis system 202 such as OS 276. OS 276 may be an operating system (OS) of analysis system 202 that provides an execution environment for one or more programs and/or processes of analysis system 202, such as any one or more of components 226, 204, 206, 222, 224, 278, 208, 216, 210, 212, and 214.

Storage device 274 may store and execute the software components of analysis system 202 in containers. Storage device 274 may store and execute the software components in containers to enable the software components to execute (e.g., stop and start) on different types of operating systems and hardware. In addition, storage device 274 may store and execute the software components in containers to enhance security of the software components and to open only the required ports between the containers and a network (e.g., network 170 as illustrated in FIG. 1). In some examples, storage device 274 may store the software components in docker containers.

Storage devices 274 include proxy server 204. Proxy server 204 may enable computing devices and/or system such as user system 150 to interact with analysis system 202. Proxy server 204 may enable a secure communication session between user system 150 and analysis server 202. For example, proxy server 204 may establish an encrypted and secure communication session between user system 150 and analysis system 202 based on validating user system 150. Proxy server 204 may validate user system 150 using a certificate allocated to user system 150. For example, proxy server 204 may validate a user certificate to determine whether user system 150 is authorized to connect to analysis system 202. Based on validating user system 150, proxy server 204 may open one or more ports to enable user system 150 to access the functionality of analysis system 202.

Proxy server 204 may enable a user of user system 150 to login to analysis system 202. Proxy server 204 may validate user credentials entered by a user of user system 150 and received from user system 150 as well as an Internet Protocol (IP) address of user system 150. For example, proxy server 204 may compare the IP address of user system 150 and user credentials received from user system 150 to a whitelist to determine whether to allow user system 150 to access one or more functions of analysis system 150. Proxy server 204 may compare the IP address and/or user credentials to a whitelist configured by a network administrator to prevent unauthorized user interface nodes from being used. For example, a network administrator may configure proxy server 204 with user credentials to control access to the functions and data of analysis server 202. Proxy server 204 may determine, based on the user credentials and/or IP address, what data may be accessed by the user. For example, proxy server 204 may determine that a given user is allowed to access a particular set of media files and functions of analysis server 202 based on the user credentials and the IP address of user system 150.

Storage devices 274 include query server 206. Query server 206 may be a program, process, or component of analysis system 202 that facilitates one or more functions of analysis system. Query server 206 may manage functions such as an initial enrollment of speakers and keywords, enrollment of new speakers and keywords, data crawling of sources of data, managing crawled data, managing speaker and keyword/phrase watchlists, generating indications to user system 150, and other functionality of analysis system 202. Query server 206 may receive indications from user system 150 regarding one or more modes query server 206 may operate in such as a “manual” mode or an “automatic” mode.

In some examples, query server 206 may operate in a manual mode. Query server 206 may receive indications from user system 150 consistent with requests to operate in the manual mode and to complete a query without crawling for or adding any additional data (e.g., adding or crawling for new media files). In addition, query server 206 may support language-based searches for keywords in a variety of languages, such as English, French, Spanish, Mandarin, Korean, Farsi, Pashto, Arabic, Arabic dialects, and other languages. In an example, query server 206 receives an indication from user system 150 to complete a query for a particular keyword in Farsi without adding data to one or more databases and/or data repositories of analysis system 202. Query 206 processes the indication and operates in the manual mode to complete the query by searching the one or more databases/data repositories of analysis system 202 without obtaining or receiving additional data. Based on completing the query, query server 206 provides the results of the query to user system 150. Query server 206 may enable user system 150 to search for speakers in the manual mode. Query server 206 may receive a selection of a particular speaker (e.g., a section of audio consistent with a particular speaker, selection of an identifier of a particular speaker, etc.) and search for media files that include the particular speaker. Query server 206 may compare an embedding of the particular speaker with embeddings of speakers in other media files as part of a matching process to identify media files in which the particular speaker speaks. Query server 206 may use one or more types of matching to match embeddings, such as similarity searching, k-nearest neighbor, use of similarity metrics, etc. Query server 206 may operate in the manual mode to enable quick one-off searches of the data maintained by analysis system 202.

In some examples, query server 206 may operate in an automatic mode. Query server 206 may operate in an automatic mode that includes automatically processing media files that are added to any of the databases/repositories of analysis system 202. When operating in the automatic mode, query server 206 may automatically process data in response to a new speaker and/or keyword/phrase enrollment. In an example, query server 206 receives an indication from user system 150 to enroll a new speaker (e.g., a selection of a section of an audio file consistent with a particular speaker, receiving an audio file of a particular speaker from user system 150, etc.). Query server 206 enrolls the new speaker and compares the newly enrolled to speaker to data maintained by analysis system 202 to determine if there are any matches or correlations. Query server 206 may automatically process data in response to an addition of a new media file while in the automatic mode. In an example, one or more components of analysis system 202 obtain a media file (e.g., a crawler obtains a new media file and adds it to a database of analysis system 202, user system 150 provides a particular audio file, etc.). Query server 206 automatically causes one or more components of analysis system 202 to extract information regarding speakers detected in the media file and determine whether the extracted speakers match or are correlated with speakers on a watchlist. Query server 206 determines whether to generate an indication in the automatic mode in response to identifying a speaker in the media file. For example, query server 206 may determine that a detection score of a speaker is above a threshold value and that an indication should be generated. Query server 206 may store information regarding the identification of a speaker in master data 212.

In some examples, query server 206 may enable a user of analysis system 202 to submit non-persistent queries to analysis system 202. Query server 206 may enable a user to submit non-persistent queries that are not retained by analysis system 202 that includes user-submitted data. In an example, query server 206 enables a user to submit a media file to analysis server 202 as part of a non-persistent query. Analysis system 202 receives the media file and processes the media file. Analysis system 202 may provide a result of the analysis of the media file in a UI. Analysis system 202 may delete the results of the analysis of the user-provided media file. Analysis system 202 may enable non-persistent queries for close analysis of a media file.

Storage devices 274 include one or more storages of data such as watchlist data 208, indexed data 210, master data 212, and crawled data 214 (hereinafter referred to as “data 210-214” when described in combination). Data 210-214 may include one or more databases and/or data repositories with one or more configurations and data structures. For example, each of data 210-214 may be a respective docker-compose instance on an encrypted file system.

Storage devices 274 include master data 212. Master data 212 may include data stored in one or more data structures. For example, master data 212 may include data, such as comparison scores between watchlist items (e.g., speakers, keywords, etc.) and indexed audio used to create graphs of relationships between speakers (e.g., a visual representation of relationships between a particular speaker and other speakers). The comparison score may indicate a magnitude or significance of association between speakers. For example, a higher comparison score for two speakers may indicate a greater likelihood of a significant relationship. Query server 206 uses the information stored in watchlist data 108, indexed data 110, and crawled data 114 to populate master data 112. Query server 206 may populate master data 212 with results of queries by query server 206. For example, query server 206 may store information regarding identified matches/correlations among speakers and/or keywords in master data 212.

Storage devices 274 include watchlist data 208. Watchlist data 208 may include one or more data structures such as a data structure for a text-based keyword/phrase watchlist and a speaker watchlist that includes speaker models and/or speaker vectors. For example, analysis system 202 may add a speaker vector to watchlist data 208 in response to receiving a query from user system 150 to search media files for the speaker represented by the speaker vector. Analysis system 202 may store speakers in watchlist data 208 as represented by vectors of 512 numbers.

Analysis system 202 may enable the importing and exporting of speaker models across user accounts or instances of the system. Analysis system 208 may enable a user to select information regarding a speaker stored in one or more data stores of analysis system 202, such as indexed data 210, and export the information from analysis system 202. In addition, analysis system 208 may enable a user to provide data regarding a speaker, such as a speaker embedding and audio files, to analysis system 202 for analysis.

Analysis system 202 may map real speaker names to pseudonyms and store the pseudonyms in watchlist data 208. In addition, analysis system 202 may store an encrypted mapping of the real speaker names to the pseudonyms on user system 150 separately from watchlist data 208. Analysis system 202 may store the mapping separately from watchlist data 208 to ensure the security of the speaker names should either of user system 150 or analysis system 202 be compromised. In addition, analysis system 202 may store the encrypted mapping in user system 150 to prevent other users from knowing the real name of an enrolled speaker and only see the speaker's pseudonym (e.g., when indications are issued for a particular speaker on the user system that enrolled the speaker would see the speaker's real name and other users would see the pseudonym). Analysis system 202 may enable different users to share the encrypted mapping. In some examples, analysis system 202 may restrict the sharing of the encrypted mapping between users to sharing over a local network rather than over public communication channels.

Analysis system 202 may enable a user system such as user system 150 to store media files in watchlist data 208. Analysis system 202 may enable the storing of media files in watchlist data 208 to enable forensic comparisons between the stored media files and other media files. In an example, analysis system 202 receives a media file from user system 150. Analysis system 202 stores the media file in watchlist data 208 to enable comparisons between the media file and media files crawled and obtained by analysis system 202.

Analysis system 202 may enable watchlist data 208 with data from other instances of analysis system 202. One or more processes or components of analysis system 202 may execute on system resource shared with another instance of analysis system 202 (e.g., sharing disk space). Analysis system 202 may enable updating watchlist data 208 with data from another instance of watchlist data 208. In some examples, analysis system 202 may require a decryption key to the other instance of watchlist data 208 in order to decrypt the data from the other instance of analysis system 202.

Storage devices 274 include indexed data 210. Indexed data 210 may include an index of files processed by analysis system 202. For example, indexed data 210 may include an indexed audio database that maintains data regarding audio files and associated metadata. Analysis system 202 may process media files and store information regarding the media files in indexed data 210. Analysis system 202 may store information regarding the media files in indexed data for use in comparing and correlating speakers and/or keywords.

Storage devices 274 include crawled data 214. Crawled data 214 may include media files crawled by one or more components of analysis system 202. Analysis system 202 may store files obtained by one or more crawlers of analysis system 202 in crawled data 214. Additionally, analysis system 202 may store media files received from user system 150 in crawled data 214. Analysis system 202 may process media files in crawled data 214 to extract speakers and keywords from media files in crawled data 214.

Storage devices 274 include dark crawler 222. Dark crawler 222 may be a data crawler that crawls for and obtains media files from sources of data located within darknets, the dark web, and/or other sites not publicly available. For example, dark crawler 222 may crawl one or more web addresses that are not publicly visible such as sites on the “.onion” domain or other domain. Dark crawler 222 may access sites via an onion network. For example, dark crawler 222 may be updated to the latest standards of an onion network such as Tor. Dark crawler 222 may crawl sites that are only accessible via onion routing. Dark crawler 222 may obtain data from the sources of data and stores the crawled/obtained data in crawled data 214. In some examples, dark crawler 222 may execute as a standalone process that crawls and obtains data for analysis system 202 to process offline at a later time.

Storage devices 274 includes open crawler 224. Open crawler 224 may be a data crawler that crawls for and obtains media files from sources of data that are publicly visible or otherwise available on the open web (e.g., websites on the Clearnet). For example, open crawler 224 may crawl and obtain data from sites such as public websites, social media, and other sources of information. Open crawler 224 may incorporate features such as attribution-control, scalable web resource collection, distribution, and other features.

Open crawler 224 may include one or more application programming interface (API)-based platforms for collecting data from sources of data. Open crawler 224 may include one or more API-based platforms that include infrastructure and related installation documents in addition to scraping/collection scripts for acquiring media files. For example, open crawler 224 may include scripts that operate in a public space and obtain data from sites such as social networking platforms. Open crawler 224 may include scripts that acquire voice and audio recordings along with associated identifiable metadata. Open crawler 224 may strip out audio from multimedia files without compressing the audio and retaining the audio in the original format for further audio processing.

Open crawler 224 may include functions that enable open crawler to crawl for and obtain media files from a variety of sources of information. Open crawler 224 may accept keyword/phrase search terms to spawn media search queries. For example, open crawler 224 may receive keywords for a search and generate media search queries for a plurality of sites based on the keywords. Open crawler 224 may generate login details for platforms that require logins for access (e.g., social media sites, forums, etc.). Open crawler 224 may dynamically generate login details and access sites using the generated login details. Open crawler 224 may emulate a human user to prevent sites from blocking the generated login details for being correlated with crawler activity. For example, open crawler 224 may throttle crawling and scraping on sites with crawling prevention to avoid the sites blocking open crawler 224 and the generated login details associated with crawler 224. Open crawler 224 may store crawled and obtained data in crawled data 214.

An entity such as a network administrator may configure dark crawler 222 and open crawler 224. The network administrator may configure dark crawler 222 and/or open crawler 224 to access existing or new sites such as social networks, adapt to changing APIs, enabling or disabling scraping of the platforms, enabling offline scraping for later ingestion to the system, and/or defining the length of time that obtained media files and/or audio is retained for reviewing detections. Additionally, dark crawler 222 and/or open crawler 224 may operate with a configurable limit to the amount of audio that can be obtained and added to crawled data 214. For example, dark crawler 222 and/or open crawler 224 may pause crawling and/or scaping media files until audio analysis module 216 has digested a sufficient amount of media files and analysis system 202 releases storage space for further crawling and scraping.

Storage devices 274 includes VPN engine 226. VPN engine 226 may be a program, process, or plugin that enables access to one or more sites for dark crawler 222 and/or open crawler 224. For example, VPN engine 226 may provide secure access to a network such as WAN 170 as illustrated in FIG. 1. VPN engine 226 may instantiate a VPN between dark crawler 222 and/or open crawler 224 and one or more sites/sources of information.

Storage devices 274 include audio analysis module 216. Audio analysis module 216 may be program or process executed by analysis system 202. Audio analysis module 216 may analyze media files as part of an audio processing workflow. Audio analysis module 216 may analyze both speaker enrollment data and obtained audio during the audio processing workflow. In some examples, audio analysis module 216 may analyze one or more media files in parallel during the audio processing workflow. Audio analysis module 216 may limit the processing of media files to only once per media file due to the computationally intensive nature of processing the media files. For example, audio analysis module 216 may process a plurality of media files in parallel a single time to extract information from the media files. Audio analysis module 216 may index the processed media files for later queries. Audio analysis module 216 may minimize computation in processing media files and facilitate the rapid query processing using query processor 220. In addition, audio analysis module 216 may include speaker ID and keyword search plugins that are continually developed using large amounts of data.

In some examples, audio analysis module 216 may extract metadata from media files. Audio analysis module 216 may extract metadata that includes gender of speakers, audio quality of media files, origin metadata of obtained media files (e.g., media files obtained by dark crawler 222 and open crawler 224), and other information. For example, audio analysis module 216 may extract metadata from media files and store the metadata for use in generating associations between speakers and for review by a user of analysis system 202.

In some examples, audio analysis module 216 may provide a modular structure that enables the integration of various features. Audio analysis module 216 may enable the integration of features that include music detection, noise removal, and other features. Audio analysis module 216 may enable a user, such as an administrator, to install features, such as plugins, to audio analysis module 216.

Audio analysis module 216 includes audio processor 218. Audio processor 218 may be a program or process executed by analysis system 202. In some examples, audio processor 218 may include one or more hardware components (e.g., an FPGA configured to process audio data, an ASIC configured to process audio data, etc.). Audio processor 218 may process media files stored in crawled data 214 and/or other storage locations.

Audio processor 218 may determine whether speech occurs in a media file. Audio processor 218 may determine whether sufficient speech occurs in a media file to avoid further processing a media file that does not includes speech and unnecessarily expending computational resources. For example, audio processor 218 may determine that a given media file contains insufficient speech and cease processing the given media file. Audio processor 218 may include a speech detection system (e.g., a subsystem, plugin, standalone process, etc.) that is hardened and enables speech detecting in unconstrained audio conditions and/or degraded radio channel noise.

Audio processor 218 may diarize speech from media files. Audio processor 218 may diarize both language and speakers from the media files. When diarizing the media files, audio processor 218 may roughly cluster speech from the media files into single-language excerpts and single-speaker clusters. Audio processor 218 may over-segment audio of the media files to generate more clusters that are predicted than expected. Audio processor 218 may over-segment the audio of the media files to generate clusters that more likely to be “pure” (e.g., only contain a single speaker or language) and enhance the confidence of subsequent detection algorithms.

Audio processor 218 may use techniques with comparatively high levels of generalization capability. Audio processor 218 may use techniques with high levels of generalization to avoid condition sensitivity issues. For example, audio processor 218 may use techniques with high levels of generalization to avoid the need for different operating parameters to optimize audio processor 218 for each condition (e.g., telephony vs. microphones vs. noisy webcam speech).

Audio processor 218 may extract speaker and/or language embeddings from media files. Audio processor 218 may extracting speaker and/or language embeddings using overlapping windows with predetermined window size. For example, audio processor 218 may use overlapping windows with window size in a range from 1.5 seconds to 10 seconds to audio from the media files. Audio processor 218 may extract embeddings from overlapping windows from each of the media files. Audio processor 218 may apply linkage clustering based on the cosine distance of the embeddings extracted from the overlapping windows. Audio processor 218 may apply one or more types of clustering, such as the linkage clustering, variational Bayes diarization, centroid-based clustering, hierarchical clustering, density-based clustering, and/or other types of clustering. For example, audio processor 218 may apply linkage clustering by grouping clusters in a bottom-up fashion using cosine distance. Audio processor 218 may use variational Bayes diarization to re-align the output into timestamps. In some examples, audio processor 218 may skip one or more speaker diarization steps when enrolling a speaker in watchlist data 208, as the enrollment audio may contain only single speaker. Audio processor 218 may use speaker recognition using domain condition aware probabilistic linear discriminant analysis which dynamically calibrates likelihood ratios based on the conditions of the audio.

Audio processor 218 may identify the language spoken in media files processed by audio processor 218. Audio processor 218 may identify the language spoken from a list of languages in media files as part of the audio processing workflow. Audio processor 218 may use a language recognition system that is a subcomponent, subprocess, plugin, standalone process, or other type of software component to identify the language spoken. In some examples, audio processor 218 may use a language recognition system implemented at least in part with one or more hardware components (e.g., ASICs, FPGAs, etc.). Audio processor 218 may determine the correct one or more languages spoken in the media files. For example, audio processor 218 may determine that speech in a given media file is spoken in Korean and Levantine Arabic. Audio processor 218 may determine that speech spoken in media files is of a language unknown to audio processor 218. Audio processor 218 may provide an indication and/or indication to user system 150 that the media files include language unknown to audio processor 218. Audio processor 218 may be hardened to handle noisy conditions and open-source data.

Audio processor 218 may generate and index speaker representations. Audio processor 218 may generate speaker representations that are speaker embeddings extracted from the media files. Audio processor 218 may extract speaker embeddings from the media files using one or more machine learning models such as TDNN, deep neural network, q-learning model, one or more types of reinforcement models, and other types of machine learning models. Audio processor 218 may extract speaker embeddings that are representations of floating point numbers per speaker cluster. For example, audio processor 218 may extract speaker embeddings that are 512 floating point numbers per speaker cluster. Audio processor 218 may index the speaker embeddings and corresponding audio timestamps in indexed data 210.

Audio processor 218 may process speaker clusters using a gender recognition module. Audio processor 218 may include a gender recognition module that is subcomponent, subprocess, plugin, module, standalone process, or other type of software component to identify the language spoken. In some examples, audio processor 218 may use a gender recognition module implemented at least in part with one or more hardware components (e.g., FPGAs, ASICs, etc.). Audio processor 218 may associate determinations of speaker gender with the speaker embeddings (e.g., as metadata).

Audio processor 218 may generate transcripts of speech from media files processed by audio processor 218. Audio processor 218 may perform speech-to-text transcription and/or ASR. Audio processor 218 may generate transcripts in response to determining that the speech in the media files is a language for which ASR is available. For example, audio processor 218 may generate a transcript for a media file in response to determining that the speech spoken in the language file is spoken in Pashto and therefore a language for which ASR is available. Audio processor 218 may generate transcripts that are time-aligned with the spoken words in the media files. Audio processor 218 may store the transcripts in indexed data 210. Audio processor 218 may store the transcripts in indexed data 210 to enable a user and/or one or more components of analysis system 202 to search for spoken content of interest. For example, audio processor 218 may enable user system 150 to search for spoken content of interest in a transcript based on search terms in watchlist data 208. Analysis system 202 may provide one or more transcripts to user system 150 along with any indications to provide additional metadata for review by user system 150.

Audio analysis module 216 includes query processor 220. Query processor 220 may be a subcomponent, subprocess, plugin, module, standalone process, or other type of software component. In some examples, query processor 220 may include one or more hardware components (e.g., FPGAs, ASICs, etc.). Query processor 220 may orchestrate queries and/or searches. Query processor 220 may orchestrate queries and searches such as queries for particular speakers and/or keywords. For example, query processor 220 may orchestrate a search for a particular speaker in response to a request from user system 150.

Query processor 220 may process speaker enrollments. Query processor 220 may process speaker enrollments such as speaker enrollments requested by user system 150. In an example, analysis system 202 receives a request to enroll a particular speaker from user system 150. Query processor 220 processes the request and adds an entry to watchlist data 208 regarding the particular speaker. Query processor 220 searches indexed data 210 and/or master data 212 for matches with the particular speaker in watchlist data 208. Query processor 220 generates an indication of any matches and provides the indication to one or more components such as indication module 278. Query processor 220 may process speaker enrollments based on media files containing speech of a speaker received from user system 150. In addition, query processor 220 may receive an indication of a portion of an audio file selected by user system 150. In some examples, query processor 220 may use multiple media files and/or segments of audio to enroll a speaker in watchlist data 208. Query processor 220 may augment enrolled speakers as more speech from the speaker becomes available to analysis system 202. For example, query processor 220 may augment an enrolled speaker with more segments of audio to improve the accuracy of identification of other media files that include the speaker. Query processor 220 may provide an encrypted copy of the speaker vector that models the speaker while enabling personal information to remain on user system 150.

Audio analysis module 216 may use audio processor 218 and query processor 220 to score comparisons and matches between speakers in media files and enrolled speaker. Audio analysis module 216 may use a cluster-based subset scoring system to score the comparisons and matches between speakers. In an example, audio analysis module 216 maintains a set of data points (e.g., indexed data 210, master data 212, watchlist data 208, etc.) for use in exhaustive comparisons. Audio analysis module 216 uses the cluster-based scoring system to identify matches between speakers and scores for the watches while maintaining relatively low usage of memory 268 and rapid identification of the matches. Audio analysis module 216 may determine a subset of one or more speakers, where each speaker of the subset of the one or more speakers is associated with the particular speaker. As part of determining the subset, audio analysis module 216 may determine that at least one media file of a plurality of media files includes the speakers of the subset of one or more speakers and a particular speaker.

Audio analysis module 216 may include core technology that processes audio from obtained media and performs queries that includes an audio processing platform, such as OLIVE available from SRI International of Menlo Park, CA. Audio analysis module 216 may be a speech software package that allows speech technologies to be dropped in via a ‘plugin’ and may be continually being improved thanks to many users and supporters of the audio analysis software. Analysis system 202 wraps the audio analysis software to provide additional features required of a program. Analysis system 202 may leverage updates to the audio processing platform in some circumstances including bug fixes, and some task-relevant plugins such as SID and LID with minor modifications to be used in analysis system 202.

Storage devices 274 include indication module 278. Indication module 278 may be a may be a program, process, or component of analysis system 202 that manages indications. In some examples, indication module 278 may be integrated with query processor 220 and/or other components of analysis system 202. Indication module 278 may be shared between query processor 220 and a user interface of user system 150 (e.g., generating user interface 154 as illustrated in FIG. 1). Indication module 278 may generate indications and provide the indications to one or more recipients such as user system 150. In some examples, indication module 278 may generate a visual indication of an indication via output devices 266. Indication module 278 may generate indications in response to changes to master data 212. For example, indication module 278 may generate an indication in response to a change in which media files are associated with a given speaker in master data 212 (e.g., a new media file being associated with the given speaker). Indication module 278 may aggregate generated indications and provide the aggregated indications to recipients on a periodic basis. For example, indication module 278 may provide an indication of all of the indications generated in a 24-hour period of time at the end of the 24-hour period. User system 150 may configure the time period over which indication module 278 aggregates and sends the aggregated indications (e.g., send all indications that have been generated every 30 minutes, hour, 4 hours, 8 hours, etc.).

In some examples, indication module 278 performs comparisons between enrolled speakers, keywords, or key phrases and the indexed data obtained by dark crawler 222 and/or open crawler 224. Indication module 278 may execute automatically and/or manually. In automatic mode, indication module 278 run queries whenever new watchlist items are added or when new audio data is indexed. In this way, indication module 278 may use only the minimal computation to check for new detections, and comparisons already performed by the query processor 220 are not re-calculated. Indication module 278 may use the manual mode when data being enrolled (speaker or text) is not to remain in the watchlist data 208 for future detections, and/or if an obtained media file is to be processed for detections only once and should not persist in indexed data 210 for later detections. For example, when manually searching for keywords in an effort to link speakers based on spoken term usage indication module 278 may search the phrase as a ‘one off’ search to help locate connected speakers. Additionally, user system 150 may use indication module 278 in the manual mode when time is of the essence in finding detections, as manual queries may be prioritized over automatic query processing. A system administrator may configure detection parameters. In addition, a user of user system 150 may set a higher threshold if they prefer to limit indications to more confident detections. Indication module 278 may share enrollments across users of the system, and indication module 278 may enable users to suppress indications from speakers that are not of interest to them.

Indication module 278 may output indications that include indications of matches between speakers and that are based on the clustering of speakers. In an example, analysis system 202 receives a second media file for enrollment that includes speech of at least one speaker. Audio analysis module 216 processes the second media by extracting an embedding of the at least one speaker from the second media file and matching the embedding to a cluster of one or more clusters of a plurality of speakers, where each cluster of the plurality of clusters corresponds to a respective speaker of a plurality of speakers. Indication module 278 outputs, based on matching the embedding to the cluster, a second indication that includes an indication of a match between the at least one speaker and a speaker of the plurality of speakers.

Indication module 278 may generate GUIs for display one by analysis system 202 and/or other computing devices, such as user system 150. Indication module 278 may generate GUIs that include visual indications of detections by indication module 278 as displayed to the user, either immediately or in an indication queue for the user to process when ready. In an example, analysis system 202 receives an indication of a selection of a particular keyword. Indication module 278 generates an indication based on determining that at least one media file of the plurality of media files includes a speaker speaking particular keyword. Indication module 278 may display detection scores presented as log likelihood ratios (LLRs), which may indicate the strength of evidence or quality of a match. For example, indication module 278 may determine that a timestamp in an indexed media file includes multiple detected speakers and may limit the display of the speaker as needed and/or display the speakers as a ranked list. Along with each detection, indication module 278 may generate a GUI that provides access to the associated metadata (detected language, gender, audio quality assessment, and transcript), sample of audio, the video excerpt if available, and other metadata obtained with the audio. For detected speakers, indication module 278 may generate the GUI as providing the user with an option to display a speaker association graph which links the same speaker across social networking sites, and optionally to associates that they communicate with on multiple occasions. Alternatively, if keywords or phrases from the watchlist are detected, indication module 278 may generate a GUI that includes the keywords or phrases presented in context in the transcript together with the audio from the speaker saying them highlighted. Indication module 278 may enable rapid enrollment of a new speaker when text-based detections are confirmed. Indication module 278 may enable users to flag false detections for a speaker so that analysis system 202 learns from its mistakes and improves from user feedback. In an example, indication module 278 may receive an indication from a user that an alarm was a false alarm. Indication module 278 processes the indication and causes audio analysis module 216 and query server 206 to update one or more parameters based on the indication of the false alarm.

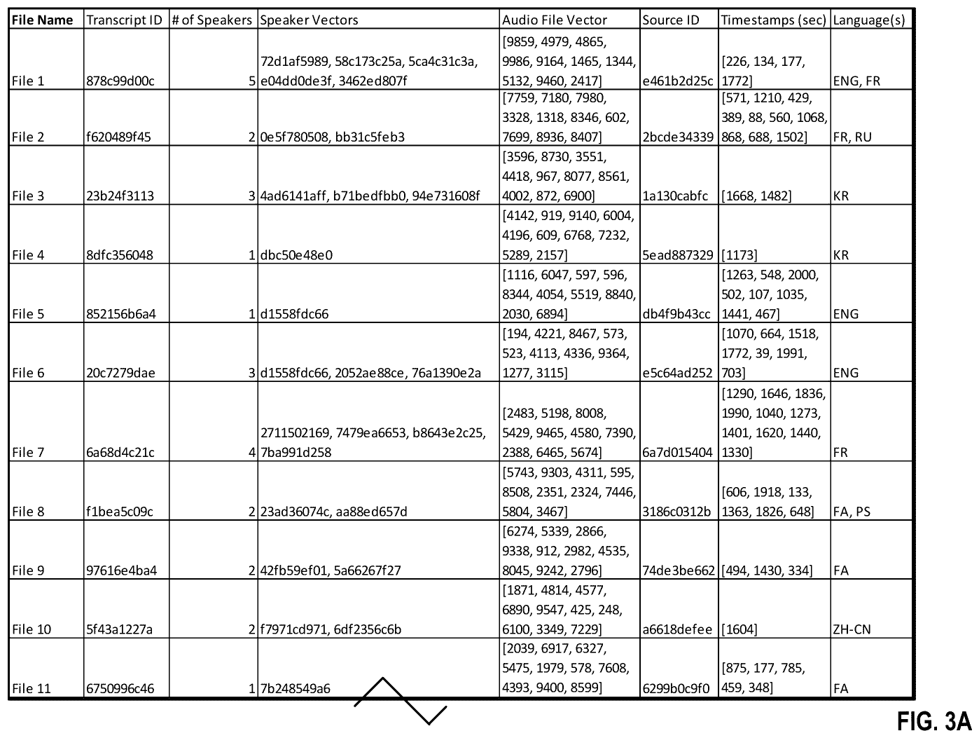

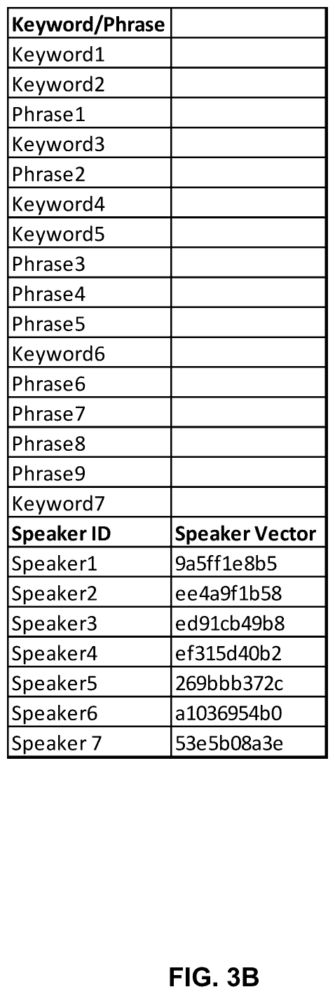

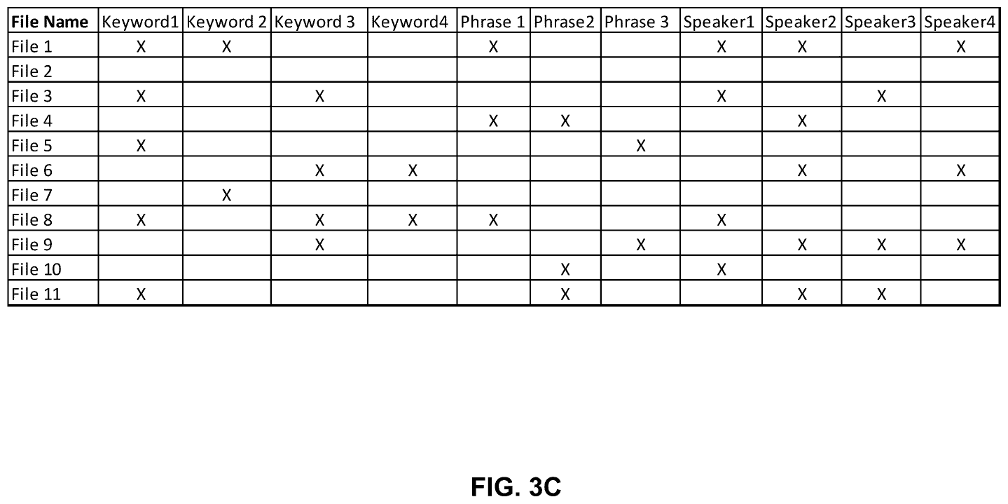

FIGS. 3A-3C depict database entries, in accordance with techniques of the disclosure. For the purposes of clarity, FIGS. 3A-3C are discussed in the context of FIG. 1.

FIG. 3A depicts entries in an index database, such as indexed data 110. Indexed data 110 may include a plurality of entries that include one or more associated variables. One or more components of analysis system 102 may modify entries of indexed data.

One or more components of analysis system 102 may organize entries in indexed data 110. For example, audio analysis module 116 may organize entries in indexed data 110 according to one or more categories, such as the name of a file (e.g., “File Name”), an identifier of a transcript associated with a media file (e.g., “Transcript ID”), the number of speakers identified within a media file (e.g., “# of Speakers”), the vectors of the speakers within the media file (e.g., “Speaker Vectors”), the vector of a media file (e.g., “Audio File Vector”), an identifier of the source of the media file (e.g., “Source ID”), timestamps of when each speaker was detected as speaking within a media file (e.g., “Timestamps (sec)”), and identifiers of the languages detected as being spoken by speakers within a media file (e.g., “Language(s)”). In some examples, indexed data 110 includes respective identifiers for multiple speakers of the one or more speakers that speak in a media file, as well as gender identifiers. Audio analysis module 116 may generate one or more correlations by identifying an association among the multiple speakers based on the identifiers for the multiple speakers that speak in the media file Audio analysis module 116 may organize the entries in indexed data 110 as entries are added or removed from indexed data 110.

Audio analysis module 116 may generate entries for indexed data 110. Audio analysis module 116 may generate, for each media file, a corresponding embedding for each speaker of speakers identified in a media file and corresponding keywords identified in the speech of the media file. In an example, audio analysis module 116 obtains a media file from crawled data 114. Audio analysis module 116 processes the media and generates an entry for indexed data 110 that includes a name of the file, an identifier for a corresponding transcript, vectors for speakers within the media file, and other information. Audio analysis module 116 updates indexed data with the entry.

One or more components of analysis system 102 may use the entries in indexed data 110. For example, query processor 120 may use indexed data 110 to identify speakers in newly crawled media files. In addition, query server 106 may provide information from indexed data 110 to a user system, such as user system 150, in response to identifying a match between a selected speaker and a speaker in indexed data 110. For example, query server 106 may provide an identifier of a speaker that is based on a speaker vector of indexed data 110 to user system 150. Further, audio analysis module 116 may match speaker included in a watchlist to the embeddings for the one or more speakers having speech in the media file

FIG. 3B depicts a watchlist entry that includes keywords and phrases and speaker identifiers to a watchlist database, such as watchlist data 108. Watchlist data 108 may include a plurality of entries similar to the one illustrated in FIG. 3B that each include one or more variables. In addition, one or more components of analysis system 102 may modify or use the entries in watchlist data 108.

Watchlist data 108 may include entries with one or more variables. The entries in watchlist data 108 may include variables that are keywords or phrases (e.g., “Keyword/Phrase”), speaker identifiers (e.g., “Speaker ID”), vectors of speakers (e.g., “Speaker Vector”), and/or other variables. For examples, the entries may include speaker identifiers that are randomly generated identifiers to represent each speaker and an associated vector for each speaker generated by audio analysis module 116. Although shown in a single table/database, the keyword/phrase and speaker ID watchlist entries may be stored and used separately.

Audio analysis module 116 may generate entries in watchlist data 108. Audio analysis module 116 may generate the entries in response to an indication from a user. In an example, audio analysis module 116 receives an indication that a user has selected a particular speaker from a media file for addition to watchlist data 108. Audio analysis module 116 processes the media file to generate an identifier for the selected speaker and a corresponding embedding. Audio analysis module 116 generates an entry in watchlist data 108 that includes the identifier and the vector.

Analysis system 102 may use the entries watchlist data 108 to identify instances of a keyword/phrase being spoken in media files, such as media files in crawled data 114. In an example, analysis system 102 obtains a new media file from a social media site using open crawler 124. Analysis system 102 processes the media file and compares the speakers identified from the media with the speaker vectors in watchlist data 108. Analysis system 102 generates an indication in response to determining that a speaker in the media file may be the same speaker as a speaker in watchlist data 108.

FIG. 3C depicts an entry in a master database, such as master data 112. Master data 112 may include one or more entries that include one include one or more variables. One or more components of analysis system 102 may modify or otherwise use master data 112.

One or more components of analysis system 102 may organize entries in master data 112. Query server 106 may generate entries for master data 112 with variables that include the name of a file (e.g., “File Name”), one or more keywords from watchlist data 108, one or more speaker names from watchlist data 108, an indicator of whether a keyword/phrase and/or speaker is present in a media file, and/or other information. For example, query server 106 may add an entry to master data 112 that includes a name of a media file and indication of speakers identified as speaking within the media file.

Query server 106 may use the entries of master data 112 to provide a user with an indication or other indication of matches between media files and entries of watchlist data 108 (e.g., particular speakers and/or keywords of watchlist data 108). In an example, query server 106 receives the results of a comparison between watchlist data 108 and a processed media file, where the results include a match between a watched speaker in watchlist data 108 and a speaker identified as speaking in the processed media file. Query server 106 generates an entry for master data 112 that includes an indication of the watched speaker and the name of the audio file and adds the entry to master data 112. Query server 106 generates an indication based on the entry and provides the indication to user system 150.

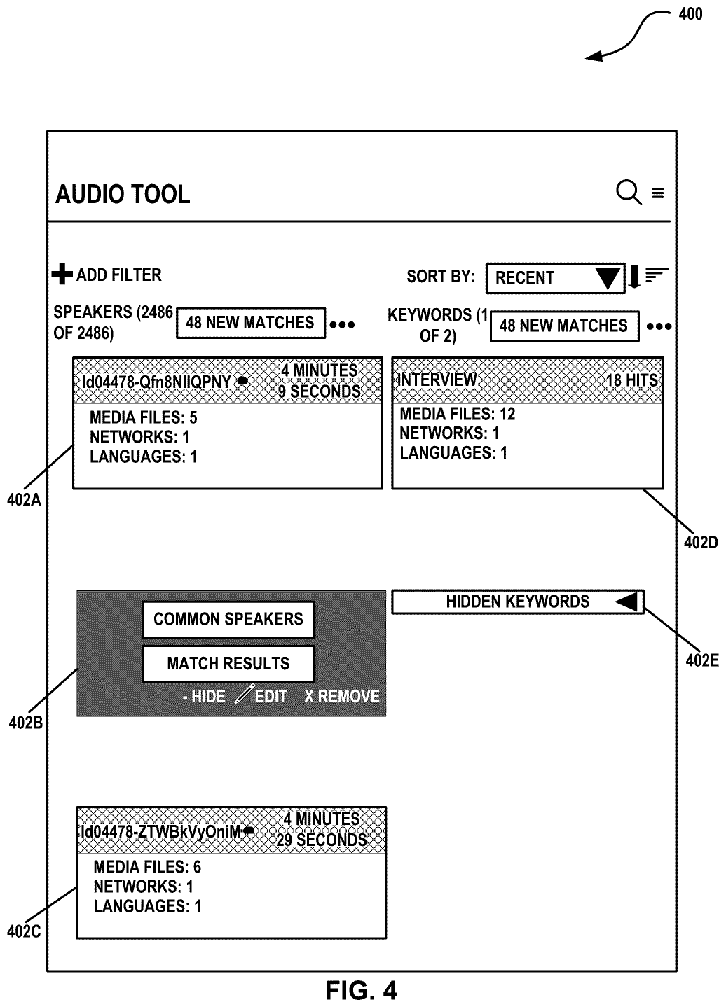

FIG. 4 is an example user interface of an analysis system, in accordance with techniques of the disclosure. For the purposes of explanation, FIG. 4 is discussed in the context of FIG. 1.

Analysis system 102 and/or user system 150 may generate graphical user interface 400 (hereinafter “GUI 400”). GUI 400 may be an example instance of user interface 154. Analysis system 102 may generate GUI 400 and provide GUI 400 to user system 150 for user system 150 to display. For example, analysis system 102 may provide interfaces for GUI 400 to user system 150 to display within a web browser of user system 150. In some examples, user system 150 may receive information from analysis system 102 and generate GUI 400 as user interface 154 based on the information received from analysis system 102.

Analysis system 102 may generate GUI 400 in response to determining that user system 150 has successfully logged into analysis system 102. Analysis system 102 may require user system 150 to authenticate and securely log in to analysis system 102 to ensure the confidentiality and security of the data maintained by analysis system 102. Analysis system 102 may authenticate user system 150. In some examples, Analysis system 102 establishes an encrypted channel with user system 150 using a reverse proxy of proxy server 104. In some examples, analysis system 102 may require user system 150 to provide login credentials in order to securely log in to analysis system 102.

Analysis system 102 may generate GUI 400 as a dashboard. Analysis system 102 may generate GUI 400 as a dashboard that displays a centralized information summary for the logged in user of user system 150. For example, analysis system 102 may generate GUI 400 as including a summary of recent searches and identified matches for particular speakers.

Analysis system 102 may generate GUI 400 as including one or more visual elements that display results of a query or an indication within the dashboard. Analysis system 102 may generate GUI 400 as including result elements 402A-402E (hereinafter “result elements 402”). Result elements 402 may be visual elements that include one or more visual sub-elements. For example, result elements 402 may include visual sub-elements that visually display an identifier of a speaker, media files in which the speaker was identified as speaking, the number of networks (e.g., sources) from which the media files were obtained, and the number of languages the speaker has been identified as speaking. In the example of FIG. 4, analysis system 400 generates GUI 400 as including result element 402C. Analysis system 102 generates result element 402C as including an identifier for a speaker (e.g., “Id04478-ZTWBkVyOniM”), a number of media files in which the speaker has been identified as speaking (e.g., 6), a total duration of time that the speaker spoke within the media files (e.g., “4 minutes 29 seconds”), a number of networks from which the media files were obtained (e.g., 1), and a number of languages that the speaker has been identified as speaking within the media files (e.g., 1).

Analysis system 102 may generate GUI 400 to enable a user of user system 150 to use functionality of analysis system 102. Analysis system 102 may provide an intuitive interface for a user to interact with analysis system 102 use one or more functions of analysis system 102. Analysis system 102 may enable a user to use system administrator functionality that includes designating a user as an administrator and enabling administrator users to use additional functionality, such as parameter changes (e.g., parameters controlling operation of one or more components, parameters for identifying speakers and/or keywords, etc.), enabling and disabling dark crawler 122 and open crawler 124, dark web onion management (e.g., managing target addresses, functions that enable scraping of data from nonpublic sites, etc.), retention parameters for data (e.g., parameters for retaining data stored in data stores that include watchlist data 108, indexed data 110, master data 112, crawled data 114, etc.), and managing user activity logs among other functionality through a GUI, such as GUI 400. Further, analysis system 102 may enable a user to use other administrative functionality that includes defining server ports of one or more modules of analysis system 102, uploading and rotating encryption keys, adjusting parameter settings such as those for error mitigation and audio storage duration, modifying user accounts, producing reports, and data logging for auditing among other functionality through a GUI, such as GUI 400.

Analysis system 102 may enable a user of user system 150 to access general functionality of analysis system 102 through GUI 500. Analysis system 102 may enable a user to use functionality that includes management of speakers or keywords, non-persistent queries for data discovery (e.g., queries that are not retained for further searching by analysis system 102), playback and downloading of obtained media files as well as subsets of media files that include speaking by a selected speaker, generating speaker network graphs to depict connections between speakers, and an analysis pane to illustrate meta information and transcriptions of audio in detections, among other functionality. Further, analysis system 102 may enable a user of user system 150 to enroll speaker models, add text queries to watchlist data 108, perform manual queries, upload speaker models to indexed data 110, view indications generated by analysis system 102, and other functions through GUI 400.

Analysis system 102 may provide GUI 400 to user system 150. Analysis system 102 may provide the data of GUI 400 to user system 150 through the secure channels via an API and/or a secure webpage. For example, analysis system 102 may provide GUI 400 to user system 150 via a secure channel for display within a web browser executed by user system 150. Analysis system 102 may provide GUI 400 as locally served and accessible through a web browser of user system 150.

Analysis system 102 may update GUI 400. Analysis system 102 may update GUI 400 over time with one or more changes, such as bug remediation and improvements to ease of use. For example, analysis system 102 may implement one or more changes to GUI 400 based on an API connected with query server 106 that are developed over time.

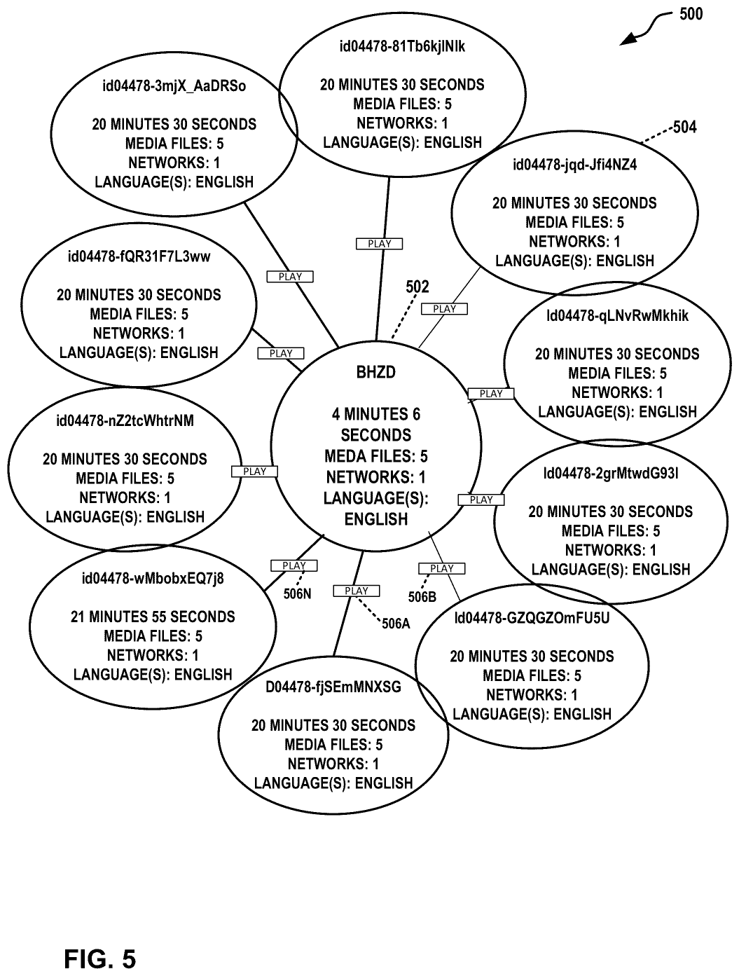

FIG. 5 is an example user interface of an analysis system, in accordance with techniques of the disclosure. For the purposes of clarity, FIG. 5 is described in the context of FIG. 1.

Analysis system 102 may generate GUI 500 based on stored data to facilitate user interaction and querying of the data. GUI 500 may be an example of user interface 154. As GUI 500 displays information regarding one or more speakers in a relational or network graph. Analysis system 102 may generate GUIs that includes visual elements representative of online interactions between speakers on various social networking platforms displayed using a graph maker software. Analysis system 102 may generate graphs that include (a) the same speaker across social media sites, (b) close connections of a speaker across a single social media site, and (c) details of common language use between speakers being displayed in the graph. In order to reduce potential clutter and false alarms, analysis system 102 may enable a user to configure the number of direct links from the main target speaker. Analysis system 102 may enable users to enroll unknown speakers of interest at a click of a button using the connecting audio found by the system. Analysis system 102 may enable users to listen to and subset the audio prior to enrolling a new speaker to ensure the audio contains only a single speaker.

Analysis system 102 may generate GUI 500 as a network graph illustrating connections and relationships (alternatively referred to as “associations” throughout) among speakers. In the example of FIG. 5, analysis system 102 generates GUI 500 as illustrating relationships between a selected speaker (“BHZD”) and several other speakers. GUI 500 illustrates one or more relationships between the selected speaker and the other speakers.

GUI 500 includes selected speaker element 502. Analysis system 102 may generate selected speaker element 502 as a visual element that includes text and/or other visual elements. In the example of FIG. 5, analysis system 102 includes selected speaker element 502 as including an identifier of a selected speaker (e.g., “BHZD”, a randomized identifier of the speaker), a total length of time that the selected speaker speaks in media files crawled by analysis system 102 (e.g., “4 minutes 6 seconds”), the media files in which the selected speaker is identified as speaking (e.g., “Media Files: 5”), the number of networks from which the media files were obtained (e.g., “Networks: 1”), and which languages the speaker has been identified as speaking (e.g., “Language(s): English”). Analysis system 102 may generate the selected speaker element 502 in response to the selection of a speaker.

Analysis system 102 may identify one or more other speakers that are related to the selected speaker. Analysis system 102 may identify the one or more speakers by identifying media files in which the selected speaker and the other speaker(s) are speaking. For example, analysis system 102 may identify eight speakers that speak with the selected speaker in media files obtained by analysis system 102.

Analysis system 102 may generate GUI 500 as including other speaker elements 504 and linking the other speaker elements 504 to selected speaker element 502 using edges. In this way, edges indicate respective relations between the speaker corresponding to selected speaker element 502 and speakers associated with the other speaker elements 504. Analysis system 102 may generate GUI 500 as including speaker elements 504 that are visual elements that include text and/or visual sub-elements. In the example of FIG. 5, analysis system 102 generates speaker elements 504 as including a visual element with a speaker identifier of “id04478-81Tb6kjINIk”, a duration of “20 minutes 30 seconds”, a number of “media files: 5”, a number of “networks: 1”, and “language(s): English”. GUI 500 may include one or more other speaker elements 504.

Analysis system 102 may generate GUI 500 as including one or more of media elements 506A-506N (collectively, “media elements 506”). Analysis system 102 may generate GUI 500 as including media elements 506 that are interactable visual elements. Media elements 506 may be interactable visual elements and enable users to play media files associated with one or more speakers. For example, analysis system 102 may generate GUI 500 as including media elements 506 as interactable visual elements that link to media files associated with one or more speakers. Responsive to the selection of a media element of media elements 506, analysis system 102 provides the audio to which the media element corresponds to. For example, responsive to selection of media element 506A associated with the edge between selected speaker element 502 and the speaker element 504 for speaker identifier “D04478-fjSEmMNXSG”, analysis system 102 may output, for playback or display to a user, audio data from one or more media files in which the corresponding speakers are speaking.

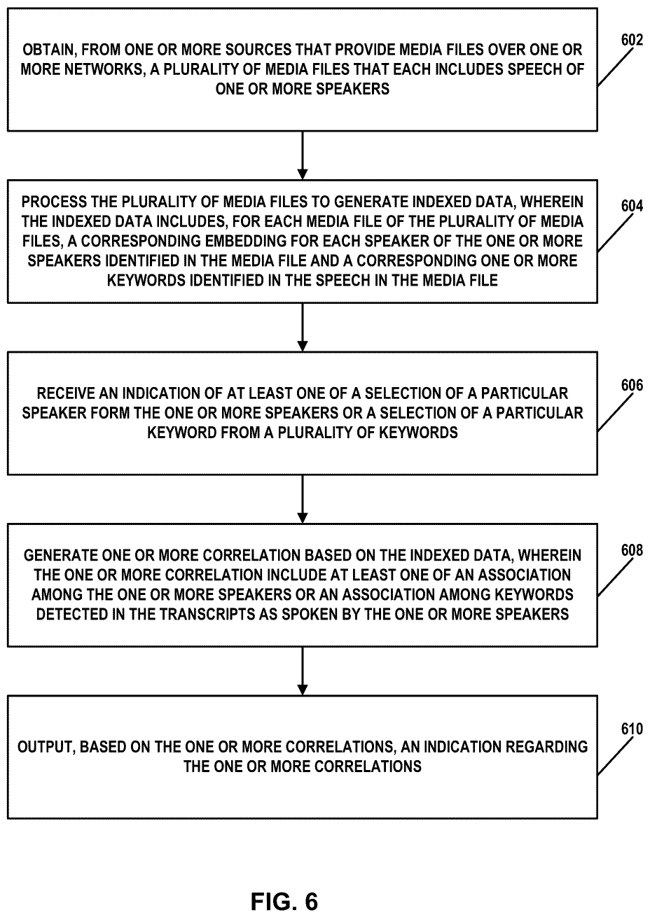

FIG. 6 is a flowchart illustrating an example mode of operation for source attribution verification, according to techniques described in this disclosure. For the purposes of clarity, FIG. 6 is described in the context of FIG. 1.

A computing system, such as analysis system 102, obtains, from one or more sources that provide media files over one or more networks, such as network 170, a plurality of media files that each includes speech of one or more speakers (602). Analysis system 102 may use one or more components to obtain media from both Clearnet sites and darknet sites. For example, analysis system 102 may use dark crawler 122 to obtain media files from darknet sites and open crawler 124 to obtain media files from Clearnet sites.

Analysis system 102 processes the plurality of media files to generate indexed data, such as indexed data 110, wherein indexed data 110 includes, for each media file of the plurality of media files, a corresponding embedding for each speaker of the one or more speakers identified in the media file and a corresponding transcript of speech for each language identified in the speech in the media file (604). Analysis system 102 may use components, such as audio analysis module 116, to process the media files. In addition to generating embeddings, audio analysis module 116 may generate identifiers for the speakers, language identifiers for the speakers, and gender identifiers for the speakers among other information. Audio analysis module 116 may generate a transcript for each language identified in the media file, such as a transcript for English, a transcript for French, etc.

Analysis system 102 receives an indication of at least one of a selection of a particular speaker from the one or more speakers or a selection of a particular keyword from a plurality of keywords (606). Analysis system 102 may receive the indication from a user system, such as user system 150. Analysis system 102 may receive an indication of a selection that includes an identifier of the particular speaker.

Analysis system 102 generates one or more correlations based on indexed data 110, where the one or more correlations include at least one of an association among the one or more speakers or an association among keywords detected in the transcripts as spoken by the one or more speakers (608). Analysis system 102 may generate the correlations by comparing speaker embeddings in indexed data 110 to speaker embeddings in watchlist data 108. In some examples, analysis system 102 may use clustering of speaker embeddings to generate the correlations.

Analysis system 102 outputs, based on the one or more correlations, an indication regarding the one or more correlations (610). Analysis system 102 may output the indication to user system 150 for display via a user interface, such as user interface 154. In some examples, analysis system 102 may output the indication as a graphical user interface that includes visual representations of correlations between speakers and/or keywords.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components or integrated within common or separate hardware or software components.

The techniques described in this disclosure may also be embodied or encoded in computer-readable media, such as a computer-readable storage medium, containing instructions. Instructions embedded or encoded in one or more computer-readable storage mediums may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

What is claimed is:

1. A method, comprising:
obtaining, by a computing system and from one or more sources that provide media files over one or more networks, a plurality of media files that each includes speech of one or more speakers;
processing, by the computing system, the plurality of media files to generate indexed data, wherein the indexed data includes, for each media file of the plurality of media files, a corresponding embedding for each speaker of the one or more speakers identified in the media file and a corresponding transcript of speech for each language identified in the speech in the media file;
receiving, by the computing system, an indication of at least one of a selection of a particular speaker from the one or more speakers or a selection of a particular keyword from a plurality of keywords;
generating, by the computing system, one or more correlations based on the indexed data, wherein the one or more correlations include at least one of an association among the one or more speakers or an association among keywords detected in the transcripts as spoken by the one or more speakers; and
outputting, by the computing system, based on the one or more correlations, an indication regarding the one or more correlations.

2. The method of claim 1, wherein processing the plurality of media files into indexed data includes clustering excerpts from the plurality of media files.

3. The method of claim 1, wherein processing the plurality of media files into indexed data includes:
extracting embeddings from overlapping windows from each of the plurality of media files; and
applying clustering to the embeddings.

4. The method of claim 1, further comprising:
generating master data by matching keywords included in a watchlist to the transcripts.

5. The method of claim 1, further comprising:
receiving, by the computing system, an indication of a selection of a particular keyword, and
wherein outputting the indication includes generating the indication based on determining that at least one media file of the plurality of media files includes a speaker speaking the particular keyword.

6. The method of claim 1, wherein the indexed data includes, for each speaker, at least one of:
a gender identifier, or
an identifier of the language spoken by the speaker.

7. The method of claim 6, further comprising:
determining, by the computing system, a subset of the one or more speakers, where each speaker of the subset of the one or more speakers is associated with the particular speaker, and wherein determining the subset includes:
determining that the speakers of the subset of one or more speakers and the particular speaker speak in a same media file.

8. The method of claim 1, further comprising:
receiving, by the computing system, an indication of a selection of a particular speaker of the one or more speakers; and
identifying, by the computing system, one or more media files that include speech by the particular speaker.

9. The method of claim 1, wherein the one or more sources comprise a Clearnet site and a darknet site.

10. The method of claim 1,
wherein the indexed data includes, for a media file of the plurality of media files, respective identifiers for multiple speakers of the one or more speakers that speak in the media file, and
wherein generating the one or more correlations based on the indexed data comprises identifying an association among the multiple speakers based on the identifiers for the multiple speakers that speak in the media file.

11. The method of claim 1, further comprising:
outputting, by the computing system, a graphical user interface (GUI), wherein the GUI includes one or more visual representations of the one or more correlations.

12. The method of claim 1, wherein processing the plurality of media files to generate the indexed data includes:
processing the plurality of media files to generate, for each media file, respective embeddings for one or more speakers having speech in the media file; and
matching speaker embeddings included in a watchlist to the embeddings for the one or more speakers having speech in the media file.

13. The method of claim 1, wherein, for each media file of the plurality of media files, the corresponding one or more keywords identified in the speech in the media file are present in a transcript of the media file.

14. The method of claim 1, wherein the media file is a first media file, wherein the indication is first indication, and further comprising:
receiving, by the computing system, a second media file of a speaker for enrollment, wherein the second media file includes speech of at least one speaker;
processing, by the computing system, the second media file, wherein processing the second media file includes:
extracting an embedding of the at least one speaker from the second media file, and
matching the embedding to a cluster of one or more clusters of a plurality of speakers, wherein each cluster of the plurality of clusters corresponds to a respective speaker of a plurality of speakers; and
outputting, by the computing system, based on matching the embedding to the cluster, a second indication that includes an indication of a match between the at least one speaker and a speaker of the plurality of speakers.

15. The method of claim 1, wherein the plurality of media files include media files with audio events, and wherein generating the correlations includes generating correlations that include associations among the audio events.

16. A computing system, comprising:
memory; and
one or more programmable processors in communication with the memory and configured to:
obtain, from one or more sources that provide media files over one or more networks, a plurality of media files that each includes speech of one or more speakers;
process the plurality of media files to generate indexed data, wherein the indexed data includes, for each media file of the plurality of media files, a corresponding embedding for each speaker of the one or more speakers identified in the media file and a corresponding transcript of speech for each language identified in the speech in the media file;
receive an indication of at least one of a selection of a particular speaker from the one or more speakers or a selection of a particular keyword from a plurality of keywords;
generate one or more correlations based on the indexed data, wherein the one or more correlations include at least one of an association among the one or more speakers or an association among keywords detected in the transcripts as spoken by the one or more speakers; and
output, based on the one or more correlations, an indication regarding the one or more correlations.

17. The computing system of claim 16, wherein to process the plurality of media files into indexed data, the one or more programmable processors are further configured to:
cluster excerpts from the plurality of media files.

18. The computing system of claim 16, wherein to process the plurality of media files into indexed data, the one or more programmable processors are further configured to:
extract embeddings from overlapping windows from each of the plurality of media files; and
apply clustering to the embeddings.

19. The computing system of claim 16, wherein the one or more programmable processors are further configured to generate master data by matching keywords included in a watchlist to the transcripts.

20. Non-transitory computer-readable media comprising instructions that, when executed by one or more processors, cause the one or more processors to:
obtain, from one or more sources that provide media files over one or more networks, a plurality of media files that each includes speech of one or more speakers;
process the plurality of media files to generate indexed data, wherein the indexed data includes, for each media file of the plurality of media files, a corresponding embedding for each speaker of the one or more speakers identified in the media file and a corresponding transcript of speech for each language identified in the speech in the media file;
receive an indication of at least one of a selection of a particular speaker from the one or more speakers or a selection of a particular keyword from a plurality of keywords;
generate one or more correlations based on the indexed data, wherein the one or more correlations include at least one of an association among the one or more speakers or an association among keywords detected in the transcripts as spoken by the one or more speakers; and
output, based on the one or more correlations, an indication regarding the one or more correlations.
